(19) United States
(12) Patent Application Publication
(10) Pub. No.: US 2026/0343613 A1
(43) Pub. Date: Oct. 29, 2026

(54) METHOD AND APPARATUS FOR TRANSMITTING PHYSICAL RANDOM ACCESS CHANNEL, DEVICE, AND READABLE STORAGE MEDIUM

(71) Applicant: Beijing Xiaomi Mobile Software Co., Ltd., Beijing (CN)

(72) Inventor: Xuemei QIAO, Beijing (CN)

(21) Appl. No.: 19/104,054

(22) PCT Filed: Aug. 17, 2022
(86) PCT No.: PCT/CN2022/113122

§ 371 Date: Feb. 14, 2025

(51) Int. Cl. H04W 74/0833; H04L 1/08

(52) U.S. Cl. CPC H04W 74/0833; H04L 1/08

(57) ABSTRACT

A method for sending a physical random access channel (PRACH) is performed by a user equipment and includes: determining, in response to a first time domain resource and a second time domain resource overlapping, a valid random access resource, wherein the first time domain resource is used for PRACH blind retransmission, and the second time domain resource is used for receiving downlink control information in a random access procedure; and performing a PRACH blind retransmission on the valid random access resource.

### CROSS-REFERENCE TO RELATED APPLICATION

The present application is a U.S. National Stage of International Application No. PCT/CN2022/113122, filed on Aug. 17, 2022, the contents of which are incorporated herein by reference in their entirety.

### TECHNICAL FIELD

The present disclosure relates to the field of wireless communication technology, and in particular, to methods and apparatuses for transmitting a physical random access channel, devices and readable storage media.

### BACKGROUND

In some wireless communication systems, in order to enhance the coverage of Physical Random Access Channel (PRACH), PRACH can be transmitted multiple times, i.e., PRACH blind retransmission can be performed.

In some implementations, a User Equipment (UE) can determine a valid Random Access Channel Occasion (RACH Occasion, RO) and perform PRACH blind retransmission during the valid RACH Occasion. When a valid RO overlaps with a downlink transmission (e.g., data, signaling, signaling) of a Random Access Response (RAR) in the time domain, there may be an impact on transceiving conversion between uplink and downlink.

### SUMMARY

In a first aspect, a method for sending a physical random access channel (PRACH) is provided, which is performed by a user equipment and including: determining, in response to a first time domain resource and a second time domain resource overlapping, a valid random access resource, where the first time domain resource is used for PRACH blind retransmission, and the second time domain resource is used for receiving downlink control information in a random access procedure; and performing a PRACH blind retransmission on the valid random access resource.

In a second aspect, a method for receiving a physical random access channel (PRACH) is provided, which is performed by a network device and including: determining, in response to a first time domain resource and a second time domain resource overlapping, a valid random access resource, where the first time domain resource is used for PRACH blind retransmission, and the second time domain resource is used for sending downlink control information in a random access procedure; and receiving a PRACH blindly retransmitted by a user equipment on the valid random access resource.

In a third aspect, an electronic device is provided, including a processor and a memory, the memory is configured to store a computer program, and the processor is configured to execute the computer program to: determine, in response to a first time domain resource and a second time domain resource overlapping, a valid random access resource, where the first time domain resource is used for PRACH blind retransmission, and the second time domain resource is used for receiving downlink control information in a random access procedure; and perform a PRACH blind retransmission on the valid random access resource.

### BRIEF DESCRIPTION OF DRAWINGS

The accompanying drawings described herein are provided to provide a further understanding of embodiments of the present disclosure and constitute a part of the present disclosure. Illustrative embodiments of the embodiments of the present disclosure and their descriptions are used to explain the embodiments of the present disclosure and do not constitute improper limitations on the embodiments of the present disclosure.

The accompanying drawings, which are incorporated in and constitute a part of the specification, illustrate embodiments consistent with the embodiments of the present disclosure, and are used together with the specification to explain the principles the embodiments of the present disclosure.

FIG. 1 is a schematic architectural diagram of a wireless communication system according to an embodiment of the present disclosure.

FIG. 2 is a schematic diagram of a method for transmitting a PRACH according to an embodiment of the present disclosure.

FIG. 3 is a schematic diagram of a method for transmitting a PRACH according to an embodiment of the present disclosure.

FIG. 4 is a schematic diagram of a method for transmitting a PRACH according to an embodiment of the present disclosure.

FIG. 5 is a schematic diagram of a method for transmitting a PRACH according to an embodiment of the present disclosure.

FIG. 6 is a schematic diagram of a method for sending a PRACH according to an embodiment of the present disclosure.

FIG. 7 is a schematic diagram of a method for sending a PRACH according to an embodiment of the present disclosure.

FIG. 8 is a schematic diagram of a method for sending a PRACH according to an embodiment of the present disclosure.

FIG. 9 is a schematic diagram of a method for sending a PRACH according to an embodiment of the present disclosure.

FIG. 10 is a schematic diagram of a method for receiving a PRACH according to an embodiment of the present disclosure.

FIG. 11 is a schematic diagram of a method for receiving a PRACH according to an embodiment of the present disclosure.

FIG. 12 is a schematic diagram of a method for receiving a PRACH according to an embodiment of the present disclosure.

FIG. 13 is a schematic diagram of a method for receiving a PRACH according to an embodiment of the present disclosure.

FIG. 14 is a structural diagram of an apparatus for sending a PRACH according to an embodiment of the present disclosure.

FIG. 15 is a structural diagram of an apparatus for sending a PRACH according to an embodiment of the present disclosure.

FIG. 16 is a structural diagram of an apparatus for receiving a PRACH according to an embodiment of the present disclosure.

FIG. 17 is a structural diagram of an apparatus for receiving a PRACH according to an embodiment of the present disclosure.

### DETAILED DESCRIPTION

Embodiments of the present disclosure are further described in connection with the accompanying drawings and specific embodiments.

Reference will now be made in detail to exemplary embodiments, examples of which are illustrated in the accompanying drawings. When the following description refers to the accompanying drawings, unless otherwise indicated, the same numbers in different accompanying drawings indicate the same or similar elements. Implementations described in the following exemplary embodiments do not represent all implementations consistent with the embodiments of the present disclosure. Rather, they are merely examples of apparatuses and methods consistent with some aspects of the present disclosure as detailed in the appended claims.

Terms used in embodiments of the present disclosure are only for a purpose of describing specific embodiments, and are not limiting the embodiments of the present disclosure. Singular forms of “a”, said”, and “the” used in the embodiments of the present disclosure and in the claims are also intended to include majority forms, unless the context clearly indicates otherwise. It should also be understood that the term “and/or” as used herein refers to any or all of the possible combinations containing one or more of the listed items in association.

It should be understood that although terms first, second, third, etc. may be used to describe various information in the embodiments of the present disclosure, these information should not be limited to these terms. These terms are used only to distinguish the same type of information from one another. For example, without departing from the scope of the present disclosure, first information can also be named as second information, and similarly, the second information can also be named as the first information. Depending on the context, the word “in a case that” and “If” as used herein can be interpreted as “at” or “when” or “in response to determining”.

Hereinafter, embodiments of the present disclosure will be described in detail, examples of which are illustrated in the accompanying drawings, where the same or similar reference numerals indicate the same or similar elements throughout. Embodiments described below by referring to the accompanying drawings are exemplary and are intended to explain the present disclosure, and should not be construed as limiting the present disclosure.

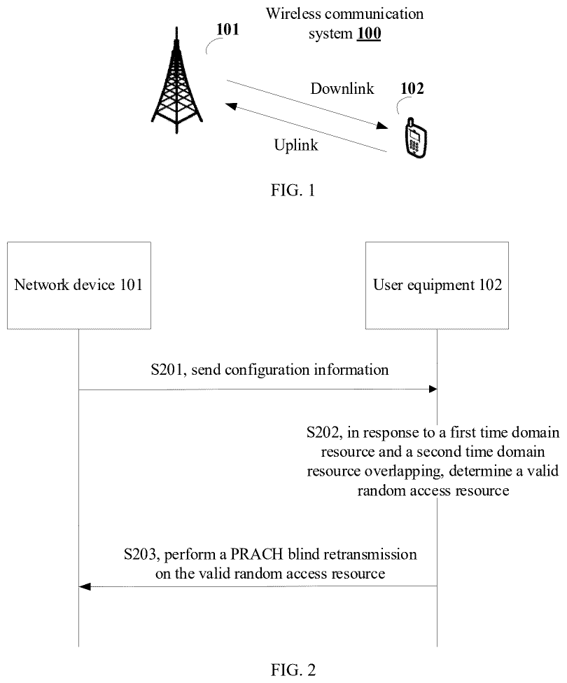

As shown in FIG. 1, a method for transmitting a PRACH provided by an embodiment of the present disclosure can be performed by a wireless communication system 100, which may include, but is not limited to, a network device 101 and a user equipment 102. The user equipment 102 is configured to support carrier aggregation, and the user equipment 102 can be connected to a plurality of carrier units of the network device 101, including a primary carrier unit and one or more secondary carrier units.

It should be understood that the above wireless communication system 100 can be applied to both low-frequency and high-frequency scenarios. Application scenarios of the wireless communication system 100 include, but are not limited to, a long term evolution (LTE) system, a frequency division duplex (FDD) system, an LTE time division duplex (TDD) system, a worldwide interoperability for micro wave access (WiMAX) communication system, a cloud radio access network (CRAN) system, a future 5th-Generation (5G) system, a new radio (NR) communication system or a future evolved public land mobile network (PLMN) system, etc.

The user equipment 102 shown above may be a user equipment (UE), a terminal, an access terminal, a terminal unit, a terminal station, a mobile station (MS), a distant station, a remote terminal, a mobile terminal, a wireless communication device, a terminal agent, or a user device, and the like. The user equipment 102 may have a wireless transceiving function, and it can communicate with one or more network devices 101 of one or more communication systems (such as wireless communication) and accept network services provided by the network devices 101, and the network device 101 here includes but not limited to the base station shown in the figure.

The user equipment 102 can be a cellular phone, a cordless phone, a session initiation protocol (SIP) phone, a wireless local loop (WLL) station, a personal digital assistant (PDA) device, a handheld device with wireless communication function, a computing device or other processing device connected to a wireless modem, a vehicle mounted device, a wearable device, a user device in future 5G networks, or a user device in future evolved PLMN networks, etc.

The network device 101 may be an access network device (or an access network point). The access network device refers to a device that provides network access functions, such as a radio access network (RAN) base station and so on. The network device may specifically include a base station (BS) device, or include a base station device and a radio resource management device for controlling the base station device. The network device may further include a relay station (relay equipment), an access point, and a base station in future 5G networks, a base station in future evolved PLMN networks or an NR base station. The network device can be a wearable device or a vehicle-mounted device. The network device can also be a communication chip with a communication module.

For example, the network device 101 may include, but is not limited to, a next-generation base station (gnodeB, gNB) in 5G, an evolved node B (eNB) in an LTE system, a radio network controller (RNC), a node B (NB) in a WCDMA system, a radio controller in a CRAN system, a base station controller (BSC), a base transceiver station (BTS) in a GSM system or a CDMA system, a home base station (e.g., home evolved nodeB, or home node B, HNB), a baseband unit (BBU), a transmission and receiving point (TRP), a transmitting point (TP), or a mobile switching center.

An embodiment of the present disclosure provides a method for transmitting a physical random access channel (PRACH). FIG. 2 is a flowchart for transmitting a PRACH according to an embodiment of the present disclosure, as shown in FIG. 2, and the method includes steps S201-S203.

At step S201, a network device sends configuration information to a user equipment, where the configuration information is used to configure PRACH repetition transmission times.

In some implementations, the configuration information indicates a first value, which corresponds to PRACH repetition transmission times (also named as the number of PRACH repetition transmission). After receiving the configuration information, the user equipment can know PRACH repetition transmission times. When performing PRACH blind retransmission, the user equipment performs the PRACH blind retransmission based on PRACH repetition transmission times.

At step S202, in response to a first time domain resource and a second time domain resource overlapping, the user equipment and the network device determine a valid random access resource.

The first time domain resource is used for blind PRACH retransmission, and the second time domain resource is used for transmitting downlink control information in a random access procedure (i.e., the second time domain resource is used for the user equipment to receive downlink control information in the random access procedure).

In some implementations, the user equipment and the network device determine the valid random access resource by using the same approach, which can be one of the following approaches.

Approach 1: determine a random access channel occasion overlapping with a type 1 common search space in a time domain as an invalid random access resource.

In an implementation, a random access channel occasion consists of a resource independently available for PRACH blind retransmission, i.e., a random access channel occasion corresponds to a resource that can be independently used for PRACH blind retransmission.

In another implementation, a random access channel occasion consists of N resources independently available for PRACH blind retransmission, where N is a positive integer. For example, N is 2, 4, 8, etc. In this implementation, if any resource used for PRACH blind retransmission overlaps with a type 1 common search space in a time domain, a random access channel occasion belonging to the resource used for PRACH blind retransmission is determined as an invalid random access resource.

For example, a random access channel occasion consists of eight resources independently available for blind PRACH retransmission, in which the first resource used for blind PRACH retransmission overlaps with the type 1 common search space in the time domain, and the other seven resources used for blind PRACH retransmission do not overlap with the type 1 common search space in the time domain, so it is determined that this random access channel occasion is invalid.

In a processing mode, after determining a plurality of random access channel occasions, each random access channel occasion is checked sequentially to determine if there is any overlap (i.e., if there is a resource used for PRACH blind retransmission that overlaps with the type 1 common search space in the time domain), and the random access channel occasion with the overlap is determined as an invalid random access channel occasion, and the random access channel occasion without the overlap is determined as a valid random access channel occasion.

Approach 2: when a random access channel occasion consists of N valid resources independently available for PRACH blind retransmission, determine the valid resource by: not determining a PRACH resource overlapping with a type 1 common search space in a time domain as the valid random access resource.

Or it can be described as: determine a PRACH resource overlapping with a type 1 common search space in a time domain as an invalid random access resource, which is not included in the random access channel occasion and is not used for PRACH blind retransmission.

For example, if the number of PRACH blind retransmissions is N, then a random access channel occasion consists of N PRACH retransmission resources. When determining a random access channel occasion (RO), it is first determined whether there are invalid resources in the first N PRACH retransmission resources. If there are invalid resources, the invalid resources will not be included in RO, and continue sequentially along the arrangement order of PRACH retransmission resources.

In an example, if the number of PRACH blind retransmissions is 8, then a random access channel occasion consists of 8 PRACH retransmission resources. When determining a random access channel occasion (RO), firstly, it is determined whether there are invalid resources in the first eight PRACH retransmission resources, if the second PRACH retransmission resource is invalid, the second PRACH retransmission resource is not included in the RO, and if the ninth PRACH retransmission resource is not invalid, the RO includes the first PRACH retransmission resource and the third to ninth PRACH retransmission resources. If the ninth PRACH retransmission resource is not an invalid resource, the ninth PRACH retransmission resource will not be counted in RO, and it will continue to determine whether there are invalid resources in the tenth PRACH retransmission resource, and so on.

The value of N is determined based on any one of:
the N is PRACH retransmission times configured by a network device; and
the N is PRACH retransmission times specified in a protocol.

Approach 3: determine a random access channel occasion located Ngap symbols after a type 1 common search space and overlapping with the second time domain resource as an invalid random access channel occasion.

Where Ngap represents the number of symbols between a valid RO located after a synchronization and PBCH block (SSB)/downlink symbol in a TDD band and the SSB/downlink symbol.

In the third approach, Ngap corresponding to a TDD band in 3GPP TS38.211 is used, which can improve the compatibility of protocols.

In Table 8.1-2 in TS 38.211, a random access preamble sub-carrier spacing (preamble SCS) has a correspondence with Ngap. As shown in Table 1:

TABLE 1

| Preamble SCS | Ngap |
|---|---|
| 1.25 kHz or 5 kHz | 0 |
| 15 kHz or 30 kHz or 60 kHz or 120 kHz | 2 |

Approach 4: determine the random access channel occasion conforming to approach 1 and a preset rule as an invalid random access resource.

The preset rule is a rule in R15 or R16 to determine a valid RO based on the TDD band. Specifically, it includes:

For paired spectrum or supplementary uplink band, all ROs are valid.

For unpaired spectrum, if a UE is not provided with tdd_UL_DL_ConfigurationCommon, a RO in a PRACH slot is valid when it meets the following conditions: it does not precede a SS/PBCH block in the PRACH slot and starts at least Ngap symbols after a last SS/PBCH block repetition symbol. If a UE provided with tdd_UL_DL_ConfigurationCommon, a RO in a PRACH slot is valid when it meets the following conditions: it is located within uplink symbols, or it does not precede a SS/PBCH block in the PRACH slot and starts at least Ngap symbols after a last SS/PBCH block repetition symbol.

Approach 5: determine a random access resource conforming to approach 2 and the preset rule as an invalid random access resource.

In some implementations, to avoid impacting the scheduling of legacy user equipment, a random access channel occasion for PRACH blind retransmission is independently configured.

In some implementations, a traditionally configured RO (legacy RO) and an independently configured RO (separate RO) are not allowed to be located on the same time domain resource but mapped to different SSB indexes. That is, when the traditionally configured RO (legacy RO) and the independently configured RO (separate RO) are located in the same time domain resource, they need to be mapped to the same SSB index.

At step S203, performing a PRACH blind retransmission on the valid random access resource.

In the embodiment of the present disclosure, when the overlapping of the first time domain resource and the second time domain resource leads to a time domain resource collision, a collision between the PRACH blind retransmission and the downlink channel transmission is prevented by determining a valid random access resource, and a transmission ambiguity between the two sides is avoided by clarifying the behaviors of the user equipment side and the network device side.

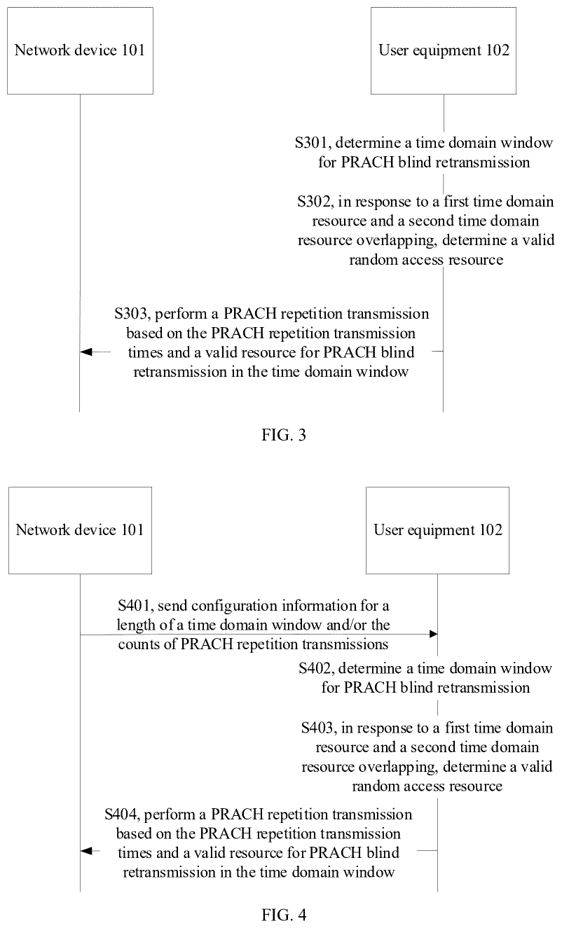

An embodiment of the present disclosure provides a method for transmitting a physical random access channel (PRACH). FIG. 3 is a flowchart for transmitting a PRACH according to an embodiment of the present disclosure, as shown in FIG. 3, and the method includes steps S301-S303.

At step S301, a user equipment determines a time domain window for PRACH blind retransmission.

In an implementation, a number of resources available for transmitting PRACH in the time domain window is greater than PRACH repetition transmission times.

The user equipment determines a time domain window for PRACH blind retransmission includes: determining a length of the time domain window and/or the PRACH repetition transmission times according to a protocol agreement.

At step S302, in response to a first time domain resource and a second time domain resource overlapping, the user equipment determines a valid random access resource.

In some implementations, determining that a valid random access resource within a random access window includes a valid random access channel occasion within the time domain window that does not overlap with a type 1 common search space and does not overlap with N gap symbols after the type 1 common search space.

At step S303, performing a PRACH repetition transmission based on the PRACH repetition transmission times and a valid resource for PRACH blind retransmission in the time domain window.

The valid resource for PRACH blind retransmission is a resource for PRACH blind retransmission within the valid random access channel occasion.

An embodiment of the present disclosure provides a method for transmitting a physical random access channel (PRACH). FIG. 4 is a flowchart for transmitting a PRACH according to an embodiment of the present disclosure, as shown in FIG. 4, and the method includes steps S401-S404.

At step S401, a network device sends configuration information to a user equipment, where the configuration information is used to configure a length of a time domain window and/or the PRACH repetition transmission times.

At step S402, a user equipment determines a time domain window for PRACH blind retransmission.

The user equipment determines a time domain window for PRACH blind retransmission includes: determining a length of the time domain window and/or the PRACH repetition transmission times according to the configuration information.

In some implementations, the number of resources available for transmitting PRACH in the time domain window is greater than PRACH repetition transmission times.

At step S403, in response to a first time domain resource and a second time domain resource overlapping, the user equipment determines a valid random access resource.

In some implementations, determining that a valid random access resource within a random access window includes a valid random access channel occasion within the time domain window that does not overlap with a type 1 common search space and does not overlap with N gap symbols after the type 1 common search space.

At step S404, performing a PRACH repetition transmission based on the PRACH repetition transmission times and a valid resource for PRACH blind retransmission in the time domain window.

The valid resource for PRACH blind retransmission is a resource for PRACH blind retransmission within the valid random access channel occasion.

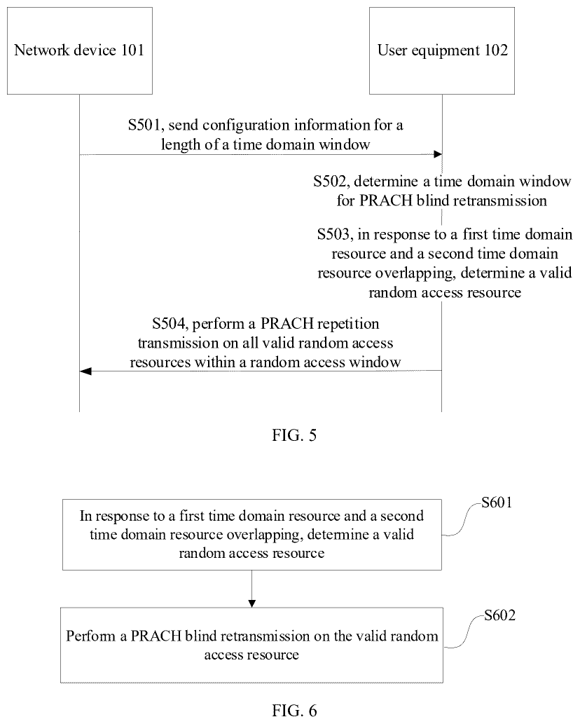

An embodiment of the present disclosure provides a method for transmitting a physical random access channel (PRACH). FIG. 5 is a flowchart for transmitting a PRACH according to an embodiment of the present disclosure, as shown in FIG. 5, and the method includes steps S501-S504.

At step S501, a network device sends configuration information to a user equipment, where the configuration information is used to configure a length of a time domain window.

At step S502, a user equipment determines a time domain window for PRACH blind retransmission.

The user equipment determines a time domain window for PRACH blind retransmission according to the configuration information.

At step S503, in response to a first time domain resource and a second time domain resource overlapping, the user equipment determines a valid random access resource.

In some implementations, in response to PRACH retransmission times (also named as the number of PRACH retransmissions) not being configured, determining that the valid random access resource includes a random access resource within the time domain window and not overlapping with a type 1 common search space.

At step S504, performing a PRACH repetition transmission on all valid random access resources within a random access window.

In another implementation, step S501 is not required, and the user equipment determines the length of the time domain window according to a protocol.

An embodiment of the present disclosure provides a method for transmitting PRACH, which includes steps S1-S4.

Steps S1-S2 are correspondingly the same as steps S501-S502 in the embodiment corresponding to FIG. 5 above.

At step S3, using a traditional method to determine a valid resource in the time domain window.

At step S4, performing PRACH repetition transmission on a PRACH resource that does not conflict with Type 1 common search space (CSS) within the PRACH repetition window.

At the same time, a PRACH resource that conflicts with a PRACH resource that conflicts with Type 1 CSS is still regarded as valid transmission resources, and a PRACH transmission occasion that conflicts with the PRACH resource that conflicts with Type 1 CSS is still regarded as valid transmission occasion.

An embodiment of the present disclosure provides a method for transmitting a PRACH, and the method includes steps S601-S603.

At S601, a network device sends invalid symbol configuration information (invalidesymbolconfiginfo) to a user equipment.

The invalid symbol configuration information (invalidesymbolconfiginfo) is used to indicate an invalid symbol.

In some implementations, the network device sends invalid symbol configuration information to the user equipment, including: the network device sends system information block 1 (SIB1) or radio resource control (RRC) signaling to the user equipment, and the SIB1 or RRC signaling includes the invalid symbol configuration information.

At S602, the user equipment determines a valid random access resource according to the invalid symbol configuration information (invalidesymbolconfiginfo).

In some implementations, determining the valid random access resource according to the invalid symbol configuration information (invalidesymbolconfiginfo) includes: not taking an invalid symbol indicated by the invalid symbol configuration information (invalidesymbolconfiginfo) as the valid random access resource.

In an example, the invalid symbol includes Ngap symbols for the user equipment to perform transceiving conversion after completing downlink reception. Then, when determining the valid random access resource, the determined valid random access resource does not include Ngap symbols for the user equipment to perform transceiving conversion after completing downlink reception.

Where Ngap represents the number of symbols between a valid RO located after a synchronization and PBCH block (SSB)/downlink symbol in a TDD band and the SSB/downlink symbol.

In some implementations, determining the valid random access resource according to the invalid symbol configuration information (invalidesymbolconfiginfo) includes: determining random access resources overlapping with N gap symbols in a time domain as invalid random access resources, where the N gap symbols follow (after) the invalid symbol indicated by the invalid symbol configuration information.

At S603, the user equipment performs PRACH blind retransmission on the valid random access resource determined in S602.

An embodiment of the present disclosure provides a method for transmitting a PRACH, and the method includes steps S701-S703.

At S701, a network device sends invalid symbol configuration information (invalidesymbolconfiginfo) to a user equipment.

The invalid symbol configuration information (invalidesymbolconfiginfo) is used to indicate an invalid symbol.

In some implementations, the network device sends invalid symbol configuration information to the user equipment, including: the network device sends SIB1 or RRC signaling to the user equipment, and the SIB1 or RRC signaling includes the invalid symbol configuration information.

At S702, the user equipment determines a valid random access resource according to an approach agreed upon in an R15/R16 protocol.

At S703, the user equipment performs a PRACH blind retransmission on the valid random access resource according to the invalid symbol configuration information (invalidesymbolconfiginfo).

The performing a PRACH blind retransmission on the valid random access resource includes: determining not to perform the PRACH blind retransmission on part of valid random access channel occasions according to invalid symbol configuration information.

In an example, the determining not to PRACH blind retransmission on part of valid random access channel occasions according to invalid symbol configuration information includes: determining part of the valid random access resource, where the part of resource includes random access resources overlapping with Ngap symbols in a time domain, and not performing a PRACH repetition transmission on the part of resource, where the Ngap symbols follow the invalid symbol indicated by the invalid symbol configuration information.

An embodiment of the present disclosure provides a method for sending a PRACH, which is performed by a user equipment. FIG. 6 is a flowchart for sending a PRACH according to an embodiment of the present disclosure, as shown in FIG. 6, and the method includes steps S601-S602.

At step S601, in response to a first time domain resource and a second time domain resource overlapping, determining a valid random access resource.

The first time domain resource is used for blind PRACH retransmission, and the second time domain resource is used for transmitting downlink control information in a random access procedure (i.e., the second time domain resource is used for the user equipment to receive downlink control information in the random access procedure).

In some implementations, the user equipment determines the valid random access resource according to any one of the above approaches 1 to 5.

At step S602, performing a PRACH blind retransmission on the valid random access resource.

In the embodiment of the present disclosure, when the overlapping of the first time domain resource and the second time domain resource leads to a time domain resource collision, a collision between the PRACH blind retransmission and the downlink channel transmission is prevented by determining a valid random access resource.

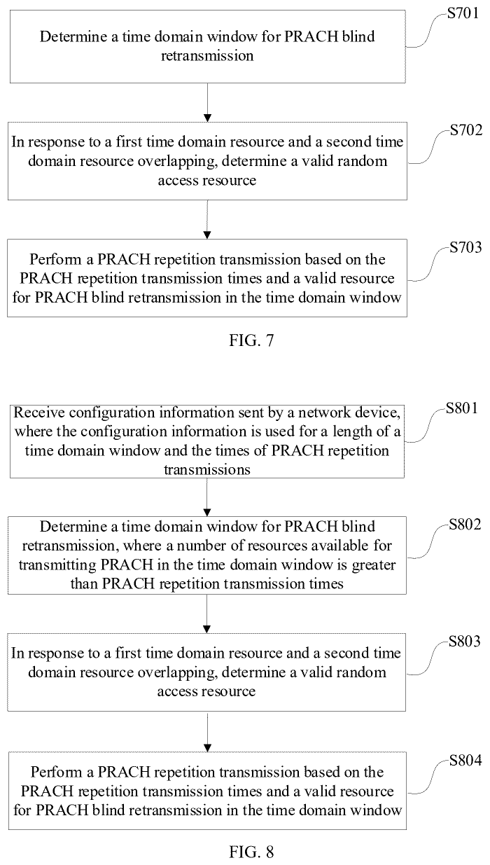

An embodiment of the present disclosure provides a method for sending a PRACH, which is performed by a user equipment. FIG. 7 is a flowchart for sending a PRACH according to an embodiment of the present disclosure, as shown in FIG. 7, and the method includes steps S701-S703.

At step S701, determining a time domain window for PRACH blind retransmission.

In some implementations, a number of resources available for transmitting PRACH in the time domain window is greater than PRACH repetition transmission times.

The user equipment determines a time domain window for PRACH blind retransmission includes: determining a length of the time domain window and/or the PRACH repetition transmission times according to a protocol agreement.

At step S702, in response to a first time domain resource and a second time domain resource overlapping, determining a valid random access resource.

In some implementations, determining that a valid random access resource within a random access window includes a valid random access channel occasion within the time domain window that does not overlap with a type 1 common search space and does not overlap with Ngap symbols after the type 1 common search space.

At step S703, performing a PRACH repetition transmission based on the PRACH repetition transmission times and a valid resource for PRACH blind retransmission in the time domain window.

The valid resource for PRACH blind retransmission is a resource for PRACH blind retransmission within the valid random access channel occasion.

An embodiment of the present disclosure provides a method for sending a PRACH, which is performed by a user equipment. FIG. 8 is a flowchart for sending a PRACH according to an embodiment of the present disclosure, as shown in FIG. 8, and the method includes steps S801-S804.

At step S801, receiving configuration information sent by a network device, where the configuration information is used for a length of a time domain window and the PRACH repetition transmission times.

At step S802, determining a time domain window for PRACH blind retransmission, where a number of resources available for transmitting PRACH in the time domain window is greater than PRACH repetition transmission times.

The user equipment determines a time domain window for PRACH blind retransmission includes: determining a length of the time domain window and/or the PRACH repetition transmission times according to the configuration information.

At step S803, in response to a first time domain resource and a second time domain resource overlapping, determining a valid random access resource.

In some implementations, determining that a valid random access resource within a random access window includes a valid random access channel occasion within the time domain window that does not overlap with a type 1 common search space and does not overlap with N gap symbols after the type 1 common search space.

At step S804, performing a PRACH repetition transmission based on the PRACH repetition transmission times and a valid resource for PRACH blind retransmission in the time domain window.

The valid resource for PRACH blind retransmission is a resource for PRACH blind retransmission within the valid random access channel occasion.

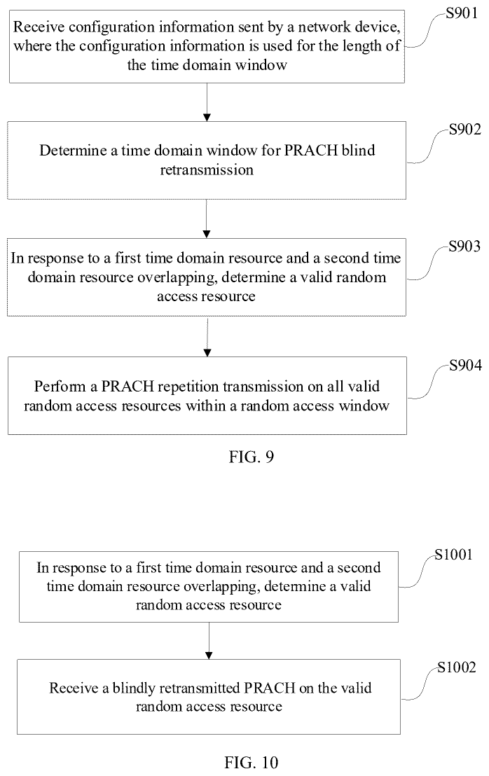

An embodiment of the present disclosure provides a method for sending a PRACH, which is performed by a user equipment. FIG. 9 is a flowchart for sending a PRACH according to an embodiment of the present disclosure, as shown in FIG. 9, and the method includes steps S901-S904.

At step S901, receiving configuration information sent by a network device, where the configuration information is used for the length of the time domain window.

At step S902, determining a time domain window for PRACH blind retransmission.

The user equipment determines a time domain window for PRACH blind retransmission according to the configuration information.

At step S903, in response to a first time domain resource and a second time domain resource overlapping, determining a valid random access resource.

In some implementations, determining that a valid random access resource within a random access window includes a valid random access channel occasion within the time domain window that does not overlap with a type 1 common search space and does not overlap with N gap symbols after the type 1 common search space.

At step S904, performing a PRACH repetition transmission on all valid random access resources within a random access window.

In another implementation, step S901 is not required, and the user equipment determines the length of the time domain window according to a protocol.

An embodiment of the present disclosure provides a method for transmitting PRACH, which is performed by a user equipment, and the method includes steps S1-S4.

Steps S1-S2 are correspondingly the same as steps S901-S902 in the embodiment corresponding to FIG. 9 above.

At step S3, using a traditional method to determine a valid resource in the time domain window.

At step S4, performing PRACH repetition transmission on a PRACH resource that does not conflict with Type 1 CSS within the PRACH repetition window.

At the same time, a PRACH resource that conflicts with a PRACH resource that conflicts with Type 1 CSS is still regarded as valid transmission resources, and a PRACH transmission occasion that conflicts with the PRACH resource that conflicts with Type 1 CSS is still regarded as valid transmission occasion.

An embodiment of the present disclosure provides a method for receiving a PRACH, which is performed by a network device. FIG. 10 is a flowchart for receiving a PRACH according to an embodiment of the present disclosure, as shown in FIG. 10, and the method includes steps S1001-S1002.

At step S1001, in response to a first time domain resource and a second time domain resource overlapping, determining a valid random access resource.

The first time domain resource is used for blind PRACH retransmission, and the second time domain resource is used for transmitting downlink control information in a random access procedure (i.e., the second time domain resource is used for the network device to send downlink control information in the random access procedure).

In some implementations, the network device determines the valid random access resource according to any one of the above approaches 1 to 5.

At step S1002, receiving a blindly retransmitted PRACH on the valid random access resource.

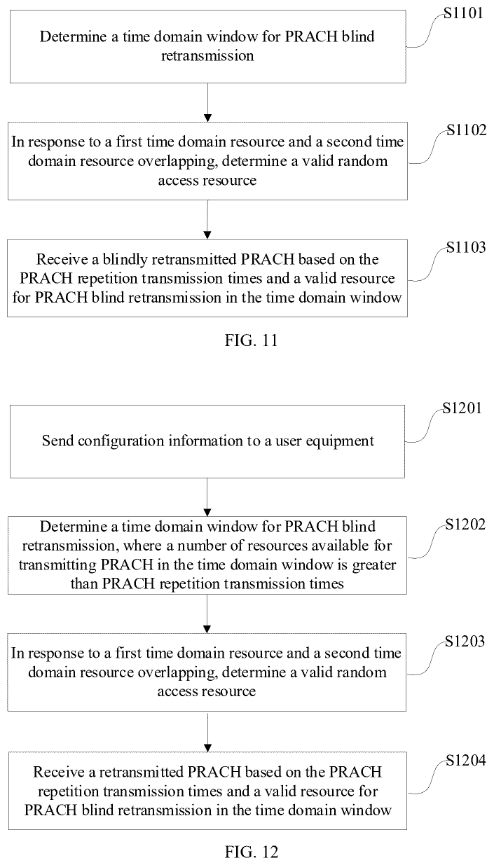

An embodiment of the present disclosure provides a method for receiving a PRACH, which is performed by a network device. FIG. 11 is a flowchart for receiving a PRACH according to an embodiment of the present disclosure, as shown in FIG. 11, and the method includes steps S1101-S1103.

At step S1101, determining a time domain window for PRACH blind retransmission, where a number of resources available for transmitting PRACH in the time domain window is greater than PRACH repetition transmission times.

The determining a time domain window for PRACH blind retransmission includes: determining a length of the time domain window and/or the PRACH repetition transmission times according to a protocol agreement.

At step S1102, in response to a first time domain resource and a second time domain resource overlapping, determining a valid random access resource.

In some implementations, determining that a valid random access resource within a random access window includes a valid random access channel occasion within the time domain window that does not overlap with a type 1 common search space and does not overlap with N gap symbols after the type 1 common search space.

At step S1103, receiving a blindly retransmitted PRACH based on the PRACH repetition transmission times and a valid resource for PRACH blind retransmission in the time domain window.

The valid resource for PRACH blind retransmission is a resource for PRACH blind retransmission within the valid random access channel occasion.

An embodiment of the present disclosure provides a method for receiving a PRACH, which is performed by a network device. FIG. 12 is a flowchart for receiving a PRACH according to an embodiment of the present disclosure, as shown in FIG. 12, and the method includes steps S1201-S1204.

At step S1201, sending configuration information to a user equipment, where the configuration information is used for a length of a time domain window and/or the PRACH repetition transmission times.

At step S1202, determining a time domain window for PRACH blind retransmission, where a number of resources available for transmitting PRACH in the time domain window is greater than PRACH repetition transmission times.

The determining a time domain window for PRACH blind retransmission includes: determining a length of the time domain window and/or the PRACH repetition transmission times according to the configuration information.

At step S1203, in response to a first time domain resource and a second time domain resource overlapping, determining a valid random access resource.

In some implementations, determining that a valid random access resource within a random access window includes a valid random access channel occasion within the time domain window that does not overlap with a type 1 common search space and does not overlap with N gap symbols after the type 1 common search space.

At step S1204, receiving a retransmitted PRACH based on the PRACH repetition transmission times and a valid resource for PRACH blind retransmission in the time domain window.

The valid resource for PRACH blind retransmission is a resource for PRACH blind retransmission within the valid random access channel occasion.

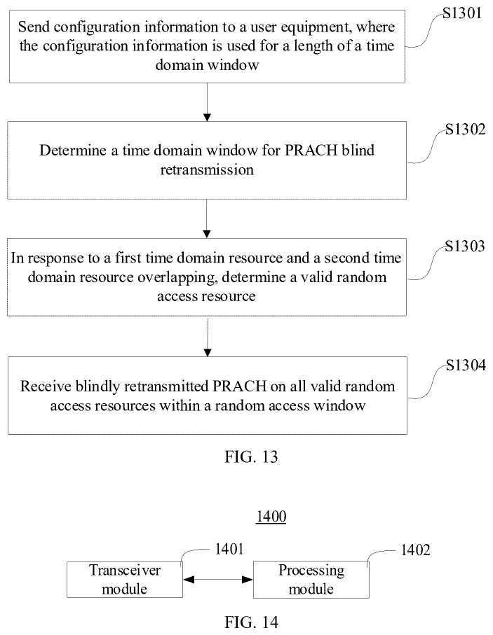

An embodiment of the present disclosure provides a method for receiving a PRACH, which is performed by a network device. FIG. 13 is a flowchart for receiving a PRACH according to an embodiment of the present disclosure, as shown in FIG. 13, and the method includes steps S1301-S1304.

At step S1301, sending configuration information to a user equipment, where the configuration information is used for a length of a time domain window.

At step S1302, determining a time domain window for PRACH blind retransmission.

The time domain window for PRACH blind retransmission is determined according to the configuration information.

At step S1303, in response to a first time domain resource and a second time domain resource overlapping, determining a valid random access resource.

In some implementations, determining that a valid random access resource within a random access window includes a valid random access channel occasion within the time domain window that does not overlap with a type 1 common search space and does not overlap with N gap symbols after the type 1 common search space.

At step S1304, receiving blindly retransmitted PRACH on all valid random access resources within a random access window.

Based on the same concept as the above method embodiment, an embodiment of the present disclosure further provides a communication apparatus, which can have the functions of the user equipment 102 in the above method embodiments, and is configured to perform the steps provided in the above embodiment to be performed by the user equipment 102. These functions can be realized by hardware, or by software or hardware executing corresponding software. The hardware or software includes one or more modules corresponding to the above functions.

In an implementation, the communication apparatus 1400 shown in FIG. 14 can be used as the user equipment 102 involved in the above method embodiments, and perform the steps performed by the user equipment 102 in the above method embodiments.

The communication apparatus 1400 include may include a transceiver module 1401 and a processing module 1402.

The processing module 1402 is configured to determine, in response to a first time domain resource and a second time domain resource overlapping, a valid random access resource, where the first time domain resource is used for PRACH blind retransmission, and the second time domain resource is used for receiving downlink control information in a random access procedure; and

the transceiver module 1401 is configured to perform a PRACH blind retransmission on the valid random access resource.

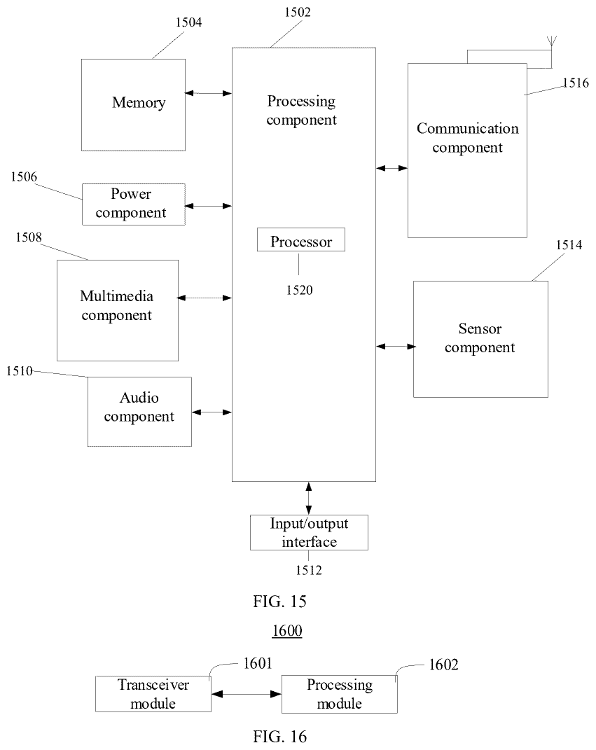

When the communication apparatus is the user equipment 102, the structure can further be as shown in FIG. 15.

FIG. 15 is a block diagram of an apparatus 1500 for receiving a downlink channel according to an embodiment of the present disclosure. For example, the apparatus 1500 may be a mobile phone, a computer, a digital broadcasting terminal, a messaging device, a game console, a tablet device, a medical device, a fitness device, a personal digital assistant, etc.

Referring to FIG. 15, the apparatus 1500 may include one or more of the following components: a processing component 1502, a memory 1504, a power component 1506, a multimedia component 1508, an audio component 1510, an input/output (I/O) interface 1512, a sensor component 1514, and a communication component 1516.

The processing component 1502 generally controls the overall operation of the apparatus 1500, such as operations associated with display, telephone call, data communication, camera operation and recording operation. The processing component 1502 may include one or more processors 1520 to execute instructions to complete all or part of steps of the above-mentioned method. In addition, the processing component 1502 may include one or more modules to facilitate interactions between the processing component 1502 and other components. For example, the processing component 1502 may include a multimedia module to facilitate interactions between the multimedia component 1508 and the processing component 1502.

The memory 1504 is configured to store various types of data to support operations in the device 1500. Examples of these data include instructions of any application program or method for being operated on the apparatus 1500, contact data, phone book data, messages, pictures, videos, etc. The memory 1504 can be implemented by any type of volatile or non-volatile memory device or combinations thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 1506 provides power to various components of the apparatus 1500. The power component 1506 may include a power management system, one or more power supplies, and other components associated with generating, managing and distributing power for the apparatus 1500.

The multimedia component 1508 includes a screen that provides an output interface between the apparatus 1500 and a user. In some embodiments, the screen may include a liquid crystal display (LCD) and a touch panel (TP). If the screen includes a touch panel, the screen may be implemented as a touch screen to receive an input signal from a user. The touch panel includes one or more touch sensors to sense touching, sliding and gestures on the touch panel. The touch sensor may not only sense a boundary of a touching or sliding action, but also detect a duration and a pressure related to the touching or sliding operation. In some embodiments, the multimedia component 1508 includes a front camera and/or a rear camera. When the device 1500 is in an operation mode, such as a shooting mode or a video mode, the front camera and/or the rear camera can receive external multimedia data. Each front camera and rear camera may be a fixed optical lens system or have focal length and optical zoom capability.

The audio component 1510 is configured to output and/or input audio signals. For example, the audio component 1510 includes a microphone (MIC) configured to receive external audio signals when the apparatus 1500 is in the operation mode, such as a calling mode, a recording mode and a voice recognition mode. The received audio signal may be further stored in the memory 1504 or transmitted via the communication component 1516. In some embodiments, the audio component 1510 further includes a speaker for outputting audio signals.

The I/O interface 1512 provides an interface between the processing component 1502 and peripheral interface modules, where the peripheral interface modules may be keyboards, click-wheels, buttons, etc. These buttons may include, but are not limited to: home button, volume button, start button and lock button.

The sensor component 1514 includes one or more sensors for providing various aspects of state evaluation for the apparatus 1500. For example, the sensor component 1514 can detect an on/off state of the device 1500, a relative positioning of components, for example, the components are the display and the keypad of the apparatus 1500, and the sensor component 1514 can also detect a position change of the apparatus 1500 or a component of the apparatus 1500, presence or absence of user contact with the apparatus 1500, orientation or acceleration/deceleration of the apparatus 1500 and a temperature change of the apparatus 1500. The sensor component 1514 may include a proximity sensor configured to detect presence of a nearby object without any physical contact. The sensor component 1514 may also include an optical sensor, such as a CMOS or CCD image sensor, for use in imaging applications. In some embodiments, the sensor component 1514 may further include an acceleration sensor, a gyroscope sensor, a magnetic sensor, a pressure sensor or a temperature sensor.

The communication component 1516 is configured to facilitate wired or wireless communication between the apparatus 1500 and other devices. The apparatus 1500 can access a wireless network based on communication standards, such as WiFi, 4G or 5G, or combinations thereof. In an embodiment of the present disclosure, the communication component 1516 receives a broadcast signal or broadcast related information from an external broadcast management system via a broadcast channel. In an embodiment of the present disclosure, the communication component 1516 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment of the present disclosure, the apparatus 1500 may be implemented by one or more application-specific integrated circuits (ASIC), digital signal processors (DSP), digital signal processing devices (DSPD), programmable logic devices (PLD), field programmable gate arrays (FPGA), controllers, micro-controllers, micro-processors or other electronic components, for executing the above-mentioned method.

In an embodiment of the present disclosure, a non-transitory computer-readable storage medium is further provided, such as the memory 1504 including instructions, where the instructions can be executed by a processor 1520 of the apparatus 1500 to complete the above-mentioned delay determination method. For example, the non-transitory computer-readable storage medium may be an ROM, a random access memory (RAM), a CD-ROM, a magnetic tape, a floppy disk, an optical data storage device, etc.

Based on the same concept as the above method embodiment, an embodiment of the present disclosure further provides a communication apparatus, which can have the functions of the network device 101 in the above method embodiments, and is configured to perform the steps provided in the above embodiment to be performed by the network device 101. These functions can be realized by hardware, or by software or hardware executing corresponding software. The hardware or software includes one or more modules corresponding to the above functions.

In an implementation, the communication apparatus 1600 shown in FIG. 16 can be used as the network device 101 involved in the above method embodiments, and perform the steps performed by the network device 101 in the above method embodiments.

The communication apparatus 1600 shown in FIG. 16 may include a transceiver module 1601 and a processing module 1602.

The processing module 1602 is configured to determine, in response to a first time domain resource and a second time domain resource overlapping, a valid random access resource, where the first time domain resource is used for PRACH blind retransmission, and the second time domain resource is used for sending downlink control information in a random access procedure; and

the transceiver module 1601 is configured to receive a PRACH blindly retransmitted by a user equipment on the valid random access resource.

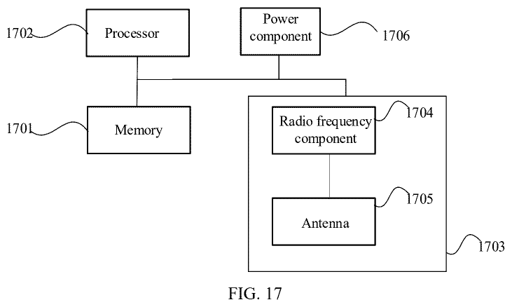

When the communication apparatus is a network device 102, the structure can further be as shown in FIG. 17. The structure of the communication apparatus will be described by taking a base station an example. As shown in FIG. 17, the apparatus 1700 includes a memory 1701, a processor 1702, a transceiver component 1703, and a power component 1706. The memory 1701 is coupled with the processor 1702 and can be configured to store programs and data necessary for the communication apparatus 1700 to implement various functions. The processor 1702 is configured to support the communication apparatus 1700 to perform the corresponding function in the above method, which can be realized by calling the programs stored in the memory 1701. The transceiver component 1703 can be a wireless transceiver, which can be configured to support the communication apparatus 1700 to receive signaling and/or data and send signaling and/or data through a wireless air interface. The transceiver module 1703 can also be named as a transceiver unit or a communication unit. The transceiver module 1703 can include a radio frequency component 1704 and one or more antennas 1705, where the radio frequency component 1704 can be a remote radio unit (RRU), which can be used for the transmission of radio frequency signals and the conversion between radio frequency signals and baseband signals, and the one or more antennas 1705 can be used for the radiation and reception of radio frequency signals.

When the communication apparatus 1700 needs to transmit data, the processor 1702 can perform baseband processing on the to-be-transmitted data, and then output a baseband signal to a radio frequency unit, and the radio frequency unit performs radio frequency processing on the baseband signal and then transmits the radio frequency signal in the form of electromagnetic waves through the antenna. When data is sent to the communication apparatus 1700, the radio frequency unit receives the radio frequency signal through the antenna, converts the radio frequency signal into a baseband signal, and outputs the baseband signal to the processor 1702, which converts the baseband signal into data and processes the data.

### INDUSTRIAL APPLICABILITY

When the overlapping of the first time domain resource and the second time domain resource leads to a time domain resource collision, a collision between the PRACH blind retransmission and the downlink channel transmission is prevented by determining a valid random access resource, and a transmission ambiguity between the two sides is avoided by clarifying the behaviors of the user equipment side and the network device side.

1. A method for sending a physical random access channel (PRACH), performed by a user equipment and comprising:
determining, in response to a first time domain resource and a second time domain resource overlapping, a valid random access resource, wherein the first time domain resource is used for PRACH blind retransmission, and the second time domain resource is used for receiving downlink control information in a random access procedure; and
performing a PRACH blind retransmission on the valid random access resource.

2. The method according to claim 1, wherein the determining a valid random access resource comprises:
determining a random access channel occasion overlapping with a type 1 common search space in a time domain as an invalid random access resource.

3. The method according to claim 1, wherein the determining a valid random access resource comprises:
when a random access channel occasion consists of N resources independently available for PRACH blind retransmission, and any resource used for PRACH blind retransmission overlaps with a type 1 common search space in a time domain, determining a random access channel occasion belonging to the resource used for PRACH blind retransmission as an invalid random access channel occasion, wherein N is a positive integer.

4. The method according to claim 1, wherein the determining a valid random access resource comprises:
when a random access channel occasion consists of N valid resources independently available for PRACH blind retransmission, not determining a PRACH resource overlapping with a type 1 common search space in a time domain as the valid random access resource, wherein N is a positive integer.

5. The method according to claim 3, wherein a value of N is determined based on any one of:
PRACH retransmission times configured by a network device; and
PRACH retransmission times specified in a protocol.

6. The method according to claim 1, wherein the determining a valid random access resource comprises:
determining a random access channel occasion located Ngap symbols after a type 1 common search space and overlapping with the second time domain resource as an invalid random access channel occasion.

7. The method according to claim 1, wherein a random access channel occasion for PRACH blind retransmission is independently configured.

8. The method according to claim 1, further comprising:
determining a time domain window for PRACH blind retransmission, wherein a number of resources available for transmitting PRACH in the time domain window is greater than PRACH repetition transmission times.

9. The method according to claim 8, wherein the determining a valid random access resource comprises:
determining that a valid random access resource within a random access window comprises a valid random access channel occasion within the time domain window that does not overlap with a type 1 common search space and does not overlap with Ngap symbols after the type 1 common search space.

10. The method according to claim 8, further comprising at least one of:
determining at least one of a length of the time domain window or the PRACH repetition transmission times according to a protocol agreement; wherein the performing a PRACH blind retransmission on the valid random access resource comprises: performing a PRACH repetition transmission based on the PRACH repetition transmission times and a valid resource for PRACH blind retransmission in the time domain window; or
receiving configuration information sent by a network device, and determining at least one of a length of the time domain window or the PRACH repetition transmission times according to the configuration information; wherein the performing a PRACH blind retransmission on the valid random access resource comprises: performing a PRACH repetition transmission based on the PRACH repetition transmission times and a valid resource for PRACH blind retransmission in the time domain window.

11. (canceled)

12. The method according to claim 1, further comprising:
determining a time domain window for PRACH blind retransmission;
the determining a valid random access resource comprising: in response to PRACH retransmission times not being configured, determining that the valid random access resource comprises a random access resource within the time domain window and not overlapping with a type 1 common search space; and
the performing a PRACH blind retransmission on the valid random access resource comprising: performing a PRACH repetition transmission on all valid random access resources within a random access window.

13. The method according to claim 1, further comprising:
receiving system information block 1 (SIB1) or radio resource control (RRC) signaling sent by a network device, wherein the SIB1 or RRC signaling comprises invalid symbol configuration information;
wherein the determining a valid random access resource comprises:
determining the valid random access resource according to the invalid symbol configuration information, wherein the invalid symbol configuration information indicates an invalid symbol, wherein the invalid symbol comprises Ngap symbols for the user equipment to perform transceiving conversion after completing downlink reception;
wherein the determining the valid random access resource according to invalid symbol configuration information comprises:
determining random access resources overlapping with Ngap symbols in a time domain as invalid random access resources, wherein the Ngap symbols follow the invalid symbol indicated by the invalid symbol configuration information.

14. (canceled)

15. (canceled)

16. The method according to claim 1, wherein the performing a PRACH blind retransmission on the valid random access resource comprises:
determining not to perform the PRACH blind retransmission on part of valid random access channel occasions according to invalid symbol configuration information, wherein the determining comprises:
determining part of the valid random access resource, wherein the part of the valid random access resource comprises random access resources overlapping with Ngap symbols in a time domain; and
not performing a PRACH repetition transmission on the part of the valid random access resource, wherein the Ngap symbols follow an invalid symbol indicated by the invalid symbol configuration information.

17. (canceled)

18. (canceled)

19. A method for receiving a physical random access channel (PRACH), performed by a network device and comprising:
determining, in response to a first time domain resource and a second time domain resource overlapping, a valid random access resource, wherein the first time domain resource is used for PRACH blind retransmission, and the second time domain resource is used for sending downlink control information in a random access procedure; and
receiving a PRACH blindly retransmitted by a user equipment on the valid random access resource.

20. The method according to claim 19, wherein the determining a valid random access resource comprises at least one of:
determining a random access channel occasion overlapping with a type 1 common search space in a time domain as an invalid random access resource;
when a random access channel occasion consists of N resources independently available for PRACH blind retransmission, and any resource used for PRACH blind retransmission overlaps with a type 1 common search space in a time domain, determining a random access channel occasion belonging to the resource used for PRACH blind retransmission as an invalid random access channel occasion;
when a random access channel occasion consists of N valid resources independently available for PRACH blind retransmission, determining the valid resource by: not determining a PRACH resource overlapping with a type 1 common search space in a time domain as the valid random access resource; or
determining a random access channel occasion located Ngap symbols after a type 1 common search space and overlapping with the second time domain resource as an invalid random access channel occasion.

21.-25. (canceled)

26. The method according to claim 19, further comprising:
determining a time domain window for PRACH blind retransmission, wherein a number of resources available for transmitting PRACH in the time domain window is greater than PRACH repetition transmission times.

27. The method according to claim 26, wherein the determining a valid random access resource comprises at least one of:
determining that a valid random access resource within a random access window comprises a valid random access channel occasion within the time domain window that does not overlap with a type 1 common search space and does not overlap with Ngap symbols after the type 1 common search space; or
in response to PRACH retransmission times not being configured, determining that the valid random access resource comprises a random access resource within the time domain window and not overlapping with a type 1 common search space; wherein the receiving a PRACH blindly retransmitted by a user equipment on the valid random access resource comprises: receiving the PRACH blindly retransmitted by the user equipment on all valid random access resources within a random access window.

28. The method according to claim 26, further comprising:
determining at least one of a length of the time domain window or the PRACH repetition transmission times according to a protocol agreement; wherein the receiving a PRACH blindly retransmitted by a user equipment on the valid random access resource comprises: receiving the PRACH blindly retransmitted by the user equipment based on the PRACH repetition transmission times and a valid resource for PRACH blind retransmission in the time domain window; or
sending configuration information to the user equipment, wherein the configuration information is used to configure at least one of a length of the time domain window or the PRACH repetition transmission times; wherein the receiving a PRACH blindly retransmitted by a user equipment on the valid random access resource comprises: receiving the PRACH blindly retransmitted by the user equipment based on the PRACH repetition transmission times and a valid resource for PRACH blind retransmission in the time domain window.

29.-33. (canceled)

34. A communication device, comprising:
a processor; and
a memory storing computer programs executable by the processor;
wherein the processor is configured to:
determine, in response to a first time domain resource and a second time domain resource overlapping, a valid random access resource, wherein the first time domain resource is used for physical random access channel (PRACH) blind retransmission, and the second time domain resource is used for receiving downlink control information in a random access procedure; and
perform a PRACH blind retransmission on the valid random access resource.

35. A communication device, comprising:
a processor; and
a memory storing computer programs executable by the processor;
wherein the processor is configured to perform the method according to claim 19.

36. (canceled)

37. (canceled)
